(19) United States
(12) Patent Application Publication
(10) Pub. No.: US 2025/0075540 A1
(43) Pub. Date: Mar. 6, 2025

(54) CAR DOOR OUTSIDE HANDLE REINFORCING METHOD AND ITS STRUCTURE

(71) Applicant: HUSHAN AUTOPARTS INC., New Taipei City (TW)

(72) Inventors: Ying-Chih Chen, New Taipei City (TW); Ching-Chiang Tsai, Taipei City (TW); Chang-Sheng Su, Keelung City (TW)

(73) Assignee: HUSHAN AUTOPARTS INC., New Taipei City (TW)

(21) Appl. No.: 18/380,683

(22) Filed: Oct. 17, 2023

(30) Foreign Application Priority Data
Aug. 28, 2023 (TW) 112132393

(51) Int. Cl. E05B 85/16

(52) U.S. Cl. CPC E05B 85/16

(57) ABSTRACT

A method and reinforcement structure of a car door outside handle, used to replace a damaged car door handle. The process involves disassembling, measuring, manufacturing reinforcing components, assembling the reinforcing parts with original components, and installation. This method allows for rapid and mass production, utilizing a structure with embedded reinforcing components to strengthen the weaker areas of the original car door outside handle. It offers advantages such as simplified structure, reduced material usage, environmental friendliness, ease of production, and efficient mass production.

### TECHNICAL FIELD

A method and structure for reinforcing the car door outside handle is used to replace a damaged car door handle, in particular to a car door outside handle which has a low cost, less material usage, is friendly to environment and easy to manufacture, which is more durable than the car door outside handle of the original factory or the car door outside handles of other manufacturers.

### BACKGROUND

When automobile manufacturers produce car door handles, the quality of materials is the key factor affecting their durability and life. Usually, if low-quality or inferior materials are used in the manufacturing process, the structure of the car door handle may be unstable and easy to break or damage in use. The car door outside handle and the door usually have two fixed parts, one end is the pivot part and the other end is the hooking part that triggers the unlocking. Usually, automobile manufacturers will choose high-quality and durable materials to produce the car door handle to ensure its long-term reliability. However, the car door handle is usually a mechanical structure that needs to be actuated most often, and it is easy to break after being used for many times, because every time the door is opened and closed, it will lead to parts wear or fatigue cracks, and the car door handle is the most affected by temperature, humidity and sunshine because it is installed outside the car, and the aging speed is faster than other parts.

In addition, the design of the handle of some models of vehicles may also have structural defects. The design does not take into account that some users are used to opening the door vigorously, which leads to excessive force on the outside handle of the door after the door lock is opened, resulting in a slight crack in the parts, which will lead to the car door handle breaking over time, such as the 2019 Benz Spinter 9-seater car. The detailed reason is that when the user opens the door vigorously, although the door lock has been opened, because the owner pulls the door quickly and vigorously, the hooking part continues to be forced to drag the whole door. Generally, the car door outside handle is not designed to let the hooking part drag the door, but its design purpose is only suitable for opening the door lock. After opening, it will be reset by elastic parts, so that other resistant structures can be forced. Although most car door outside handles can usually withstand such rough use by the user, if the user is used to opening the door in this way, the door will be opened.

### SUMMARY

In order to solve the problem that the fracture probability and service life of the hooking part of the car door outside handle will be greatly reduced, the invention relates to a reinforcing method of a car door outside handle, which is used for reinforcing the hooking part of the car door outside handle and replacing the damaged car door. The reinforcing structure of the car door outside handle of the invention is characterized by comprising a handle body, one end of which is a pivot end, and the other end is a trigger end, wherein the trigger end is provided with a hooking part protruding towards the door, and the hooking part has a stroke body and a trigger hook, one end of the stroke body is connected with the handle body, and the other end forms a hook-shaped trigger hook; and a reinforcing part with a reinforcing stroke body, one end of which forms a hook-shaped reinforcing trigger hook, and the reinforcing part is arranged at an appropriate place of the hooking part.

The main technical means of the present invention lies in that a reinforcing part is arranged at the proper place of the hooking part, and the mechanical strength of the hooking part is enhanced, so that the effect can be achieved by embedding or sticking, and the car door outside handle with the hooking part which is easy to break due to wear can be additionally provided with a reinforcing part accommodating part at the hooking part, and the reinforcing part accommodating part is arranged at the easy-to-wear place, and the original contacting surface of the hooking part is replaced by the reinforcing part; the reinforcing part can be made of metal and is more wear-resistant.

The method of the present invention is a manufacturing method of a reinforcing structure of a car door outside handle, which reinforces a hooking part of a car door handle, and includes the following steps: step S1, a measuring step: precisely measuring the hooking part of a car door outside handle; step S2, a designing step: designing a shape specification of the reinforcing part according to the shape data of the hooking part of the car door outside handle, wherein the reinforcing part needs to have a reinforcing stroke body, and one end of the reinforcing stroke body forms a hook-shaped reinforcing trigger hook; step S3, a manufacturing step: manufacturing a reinforcing part according to the design specification of the reinforcing part designed in step S2.

The secondary technical means of the present invention is to modify the car door outside handle reinforcement structure with the least number of components to obtain the lowest manufacturing cost, and to achieve the advantages of simplified structure, reduced material use, friendliness in environment, easy manufacture and rapid mass production, which can quickly mass produce and supply the market demand.

### BRIEF DESCRIPTION OF DRAWINGS

FIG. 1 is an embodiment of the present invention;

FIG. 2 is an exploded view of an embodiment of the present invention;

FIG. 3 is a manufacturing method diagram of an embodiment of the present invention; and

FIG. 4 is a cross-sectional view of the second embodiment of the present invention.

### DESCRIPTION OF EMBODIMENTS

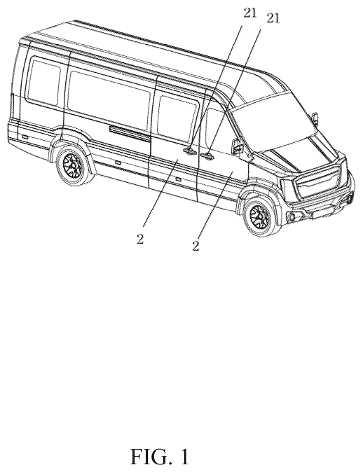

Please refer to FIG. 1, which is an embodiment of the present invention, which reveals that the present invention is a reinforcement structure for a car door outside handle for replacing a damaged car door outside handle of a car door.

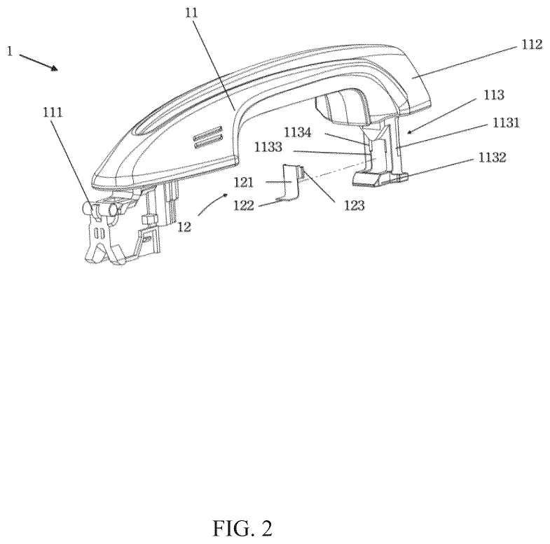

Please also refer to FIG. 2, which is an exploded view of the embodiment of the present invention, which reveals the characteristics of the present invention: a handle body, one end of which is a pivot end and the other end is a trigger end; the trigger end is provided with a hooking part protruding towards the car door, and the hooking part has a stroke body and a trigger hook; one end of the stroke body is connected with the handle body, and the other end forms a hook-shaped trigger hook; and a reinforcing part having a reinforcing stroke body, one end of which forms a hook-shaped reinforcing trigger hook, and the reinforcing part is arranged at an appropriate position of the hooking part. The method and the structure for reinforcing the car door outside handle of the invention have the advantages of simplicity in the structure, reducing the use of materials, being friendly to the environment, being easy to manufacture and being rapidly mass-produced, and can be rapidly mass-produced and supplied to the market demand.

As shown in the figure, the hooking part is further recessed with a reinforcing part accommodating part, and the reinforcing part accommodating part corresponds to one surface shape of the reinforcing part; the reinforcing part is accommodated in the reinforcing part accommodating part and closely adheres to the hooking part, and the two sides of the reinforcing part accommodating part are provided with engaging grooves; the two sides of the reinforcing part are further provided with engaging wings corresponding to the engaging grooves; the reinforcing part can be engaged with the engaging grooves through the engaging wing and closely attached to the hooking part. This structure can be applied to the car door handle outside the car, where the hooking part is easily broken due to wear. The reinforcing part is accommodated in the reinforcing part accommodating part and closely attached to the hooking part to replace the worn part of the original hooking part. The reinforcing part can be made of metal and can resist wear. In addition, engaging wings can be provided, so that the engaging wings can replace the two sides of the original hooking part to contact the friction-prone part, and the reinforcing part can be engaged with the engaging grooves through the engaging wings and closely attached to the hooking part, which can prevent the user from opening the door with great force and causing the reinforcing part to be loose.

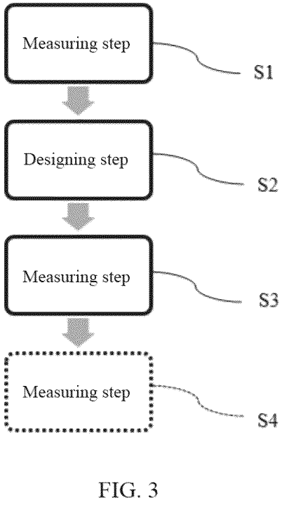

Please refer to FIG. 3, a manufacturing method according to an embodiment of the present invention, which discloses a manufacturing method of a reinforcing structure of an car door outside handle for reinforcing the hooking part of a car door handle, and includes the following steps: step S1, a measuring step: precisely measuring the hooking part of an car door outside handle; step S2, a designing step: designing a shape specification of the reinforcing part according to the shape data of the hooking part of the car door outside handle, wherein the reinforcing part needs to have a reinforcing stroke body, and one end of the reinforcing stroke body forms a hook-shaped reinforcing trigger hook; step S3, a manufacturing step: manufacturing a reinforcing part according to the design specification of the reinforcing part designed in step S2. Through three steps, the reinforcing part can be produced in large quantities quickly, which has the advantage of extremely low development cost, and a subsequent installation method of the embodiment of this invention can further have a step S4, an assembling step: closely attaching the reinforcing part to the car door outside handle to form a reinforcement structure of the car door outside handle.

In this embodiment, the second step S2, i.e., a designing step, further designs the specifications and dimensions of an car door outside handle, which has a handle body with one end as a pivot end and the other end as a trigger end, and the trigger end is provided with a hooking part protruding towards the door, the hooking part has a stroke body and a trigger hook, one end of the stroke body is connected with the handle body, and the other end forms a hook-shaped trigger hook, and the hooking part is further concavely provided with a reinforcing part accommodating part, the reinforcing part accommodating part corresponds to the shape of one surface of the reinforcing part. The third step S3, i.e., a manufacturing step, further manufactures a car door outside handle with the reinforcing part accommodating part according to the specifications and dimensions of the car door outside handle; in addition, both sides of the reinforcing part accommodating part of the door outside handle with the reinforcing part accommodating part are provided with engaging grooves, and both sides of the reinforcing part are further provided with engaging wings corresponding to the engaging grooves, and the reinforcing part is engaged with the engaging grooves through the engaging wings and closely adhered to the hooking part.

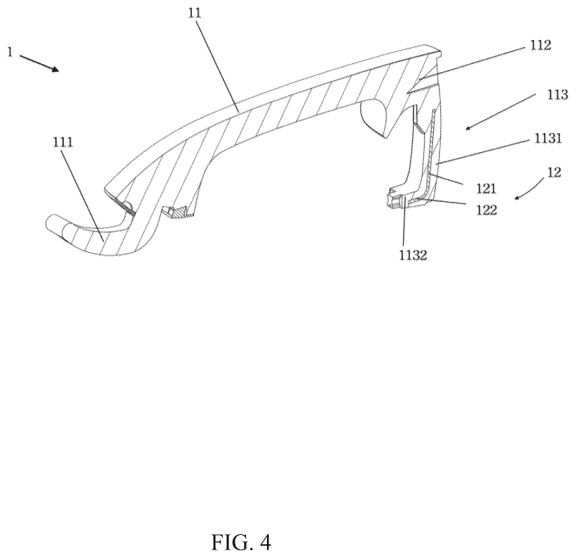

Please refer to FIG. 4, it is a cross-sectional view of the second embodiment of the present invention, and reveals that the reinforcing part can also be embedded in the hooking part. This embodiment can facilitate the manufacturer to manufacture in large quantities quickly, and its manufacturing method is as follows: step S1, a measuring step: precisely measuring the hooking part of an car door outside handle; step S2, a designing step: designing a shape specification of the reinforcing part according to the shape data of the hooking part of the car door outside handle, wherein the reinforcing part needs to have a reinforcing stroke body, and one end of the reinforcing stroke body forms a hook-shaped reinforcing trigger hook; step S3, a manufacturing step: manufacturing a reinforcing part according to the design specification of the reinforcing part designed in step S2; manufacturing the door outside handle in copies, and placing the reinforcing part into a mould in advance when manufacturing the door outside handle in copies, so that the reinforcing part is embedded in the hooking part of the door outside handle.

Through the method of the present invention, it is possible to manufacture a car door handle which is more durable than the original car door handle or the car door handle of other manufacturers, and has the advantages of low cost, less material use, friendliness to environment and easy manufacture, which can reduce the pollution to the environment and reduce the manufacturing cost, and can also contribute to the sustainable development of enterprises or the earth.

What is claimed is:

1. A reinforcement structure of a car door outside handle, wherein the structure is used for replacing a damaged car door outside handle of a car door, and comprises:
a handle body, one end of which is a pivot end, and the other end is a trigger end, wherein the trigger end is provided with a hooking part protruding towards the door, and the hooking part has a stroke body and a trigger hook, one end of the stroke body is connected with the handle body, and the other end forms a hook-shaped trigger hook; and
a reinforcing part with a reinforcing stroke body, one end of which forms a hook-shaped reinforcing trigger hook, and the reinforcing part is arranged at an appropriate place of the hooking part.

2. The reinforcement structure of a car door outside handle according to claim 1, wherein the hooking part is further concavely provided with a reinforcing part accommodating part, and the reinforcing part accommodating part corresponds to one surface shape of the reinforcing part, and the reinforcing part is accommodated in the reinforcing part accommodating part and closely adheres to the hooking part.

3. The reinforcement structure of a car door outside handle according to claim 2, wherein both sides of the reinforcing part accommodating part are provided with engaging grooves, and both sides of the reinforcing part are further provided with engaging wings corresponding to the engaging grooves, and the reinforcing part is engaged with the engaging grooves through the engaging wings and closely adhered to the hooking part.

4. The reinforcement structure of a car door outside handle according to claim 1, wherein the reinforcing part is embedded in the hooking part.

5. The reinforcement structure of a car door outside handle according to claim 1, wherein the reinforcing part is made of metal.

6. A method for manufacturing a reinforcement structure of a car door outside handle, wherein the reinforcement structure of a car door outside handle reinforces a hooking part of a car door handle, and the method comprises:
S1, a measuring step: precisely measuring the hooking part of an car door outside handle;
S2, a designing step: designing a shape specification of the reinforcing part according to the shape data of the hooking part of the car door outside handle, wherein the reinforcing part needs to have a reinforcing stroke body, and one end of the reinforcing stroke body forms a hook-shaped reinforcing trigger hook; and
S3, a manufacturing step: manufacturing a reinforcing part according to the design specification of the reinforcing part designed in step S2.

7. The method for manufacturing a reinforcement structure of a car door outside handle according to claim 6, wherein in S3 of manufacturing a reinforcing part according to the design specification of the reinforcing part designed in step S2, the door outside handle are manufactured in copies, and the reinforcing part is placed into a mould in advance when manufacturing the door outside handle in copies, so that the reinforcing part is embedded in the hooking part of the door outside handle.

8. The method for manufacturing a reinforcement structure of a car door outside handle according to claim 6, wherein, the method further comprises a step S4, an assembling step: closely attaching the reinforcing part to the car door outside handle to form a reinforcement structure of the car door outside handle.

9. The method for manufacturing a reinforcement structure of a car door outside handle according to claim 6, wherein the second step S2, i.e., a designing step, further designs the specifications and dimensions of a car door outside handle, the car door outside handle has a handle body with one end as a pivot end and the other end as a trigger end, and the trigger end is provided with a hooking part protruding towards the door, the hooking part has a stroke body and a trigger hook, one end of the stroke body is connected with the handle body, and the other end forms a hook-shaped trigger hook, and the hooking part is further concavely provided with a reinforcing part accommodating part, the reinforcing part accommodating part corresponds to the shape of one surface of the reinforcing part; the third step S3, i.e., a manufacturing step, further manufactures a car door outside handle with the reinforcing part accommodating part according to the specifications and dimensions of the car door outside handle.

10. The method for manufacturing a reinforcement structure of a car door outside handle according to claim 9, wherein both sides of the reinforcing part accommodating part of the door outside handle with the reinforcing part accommodating part are provided with engaging grooves, and both sides of the reinforcing part are further provided with engaging wings corresponding to the engaging grooves, and the reinforcing part is engaged with the engaging grooves through the engaging wings and closely adhered to the hooking part.
